(19) United States
(12) Patent Application Publication
(10) Pub. No.: US 2022/0051050 A1
(43) Pub. Date: Feb. 17, 2022

(54) PRESENTATION OF DIGITIZED IMAGES FROM USER DRAWINGS

(71) Applicant: Micron Technology, Inc., Boise, ID (US)

(72) Inventors: Carla L. Christensen, Boise, ID (US); Zahra Hosseinimakarem, Boise, ID (US); Bhumika Chhabra, Boise, ID (US); Radhika Viswanathan, Boise, ID (US)

(21) Appl. No.: 16/991,979

(22) Filed: Aug. 12, 2020

(51) Int. Cl. G06K 9/62; G06K 9/00; G06K 9/46; G06F 3/0488; G06F 3/0482; G06F 16/51

(52) U.S. Cl. CPC G06K 9/6215; G06K 9/6202; G06K 9/00409; G06F 16/51; G06K 9/00436; G06F 3/04883; G06F 3/0482; G06K 9/4604

(57) ABSTRACT

Methods, apparatuses, and non-transitory machine-readable media for presentation of digital images from user drawings are described. Apparatuses can include a display, a memory device, and a controller. In an example, a method can include the controller receiving data representing a user drawing, identifying a feature of the user drawing based on the data, and comparing the feature of the user drawing to features of a plurality of digitized images. In another example, a particular digitized image can be displayed based on the comparison of the feature with the features of the plurality of digitized images.

### TECHNICAL FIELD

The present disclosure relates to apparatuses, non-transitory machine-readable media, and methods for presentation of digitized images from user drawings.

### BACKGROUND

A computing device is a mechanical or electrical device that transmits or modifies energy to perform or assist in the performance of human tasks. Examples include thin clients, personal computers, printing devices, laptops, mobile devices (e.g., e-readers, tablets, smartphones, etc.), internet-of-things (IoT) enabled devices, and gaming consoles, among others. An IoT enabled device can refer to a device embedded with electronics, software, sensors, actuators, and/or network connectivity which enable such devices to connect to a network and/or exchange data. Examples of IoT enabled devices include mobile phones, smartphones, tablets, phablets, computing devices, implantable devices, vehicles, home appliances, smart home devices, monitoring devices, wearable devices, devices enabling intelligent shopping systems, among other cyber-physical systems.

A computing device can include an imaging device (e.g., a camera) used to capture images. A computing device can include a display used to view images. The display can be a touchscreen display that serves as an input device. When a touchscreen display is touched by a finger, digital pen (e.g., stylus), or other input mechanism, associated data can be received by the computing device. The touchscreen display may include pictures and/or words, among others that a user can touch to interact with the device.

### BRIEF DESCRIPTION OF THE DRAWINGS

FIG. 1 is a functional block diagram in the form of a computing system including an apparatus having a display, an imaging device, a memory device, and a controller in accordance with a number of embodiments of the present disclosure.

FIG. 2 is a diagram representing an example of a user drawing on a display of a computing device in accordance with a number of embodiments of the present disclosure.

FIG. 3 is a diagram representing an example of a digitized image displayed on the display of the computing device based on the comparison of the features of the user drawing of FIG. 2 with the features of the plurality of digitized images in accordance with a number of embodiments of the present disclosure.

FIG. 4 is a functional diagram representing a processing resource in communication with a memory resource having instructions stored thereon for presentation of digitized images from user drawings in accordance with a number of embodiments of the present disclosure.

FIG. 5 is a flow diagram representing an example method for presentation of digitized images from user drawings in accordance with a number of embodiments of the present disclosure.

### DETAILED DESCRIPTION

Apparatuses, machine-readable media, and methods related to presentation of digitized images from user drawings are described. Where referred to herein, a “user drawing” or simply a “drawing” is a non-digitized drawing made by a human. Stated differently, a drawing may refer to a “hand-drawn,” rather than a “computer-drawn,” drawing. Traditionally, drawings can be made with one or more drawing tools (e.g., pencils, pens, markers, chalk, etc.) on one or more surfaces (e.g., paper, chalkboards, whiteboards, etc.). More recently, user drawings can be made with a digital pen (e.g., a stylus) or a finger on a touchscreen display.

In many scenarios, users draw an informal drawing and desire that drawing to be digitized. As referred to herein, a digitized image is an image that is computer-rendered and/or computer-readable. Embodiments of the present disclosure can receive a drawing (e.g., data representing a drawing) and present a digitized image of that drawing.

In one example, a team is in a meeting room working on a process associated with a new product launch. During that meeting, a block diagram is drawn on a lightboard, whiteboard, or poster board that depicts the steps of the process. If the team wants to present its management with the agreed-upon process, it may desire to formalize the diagram to increase its clarity and/or readability. In another example, a teacher putting together a trigonometry quiz may draw a triangle having sides that are not quite straight or a circle that is not quite circular.

In either case, and in many other cases, converting these drawings to formal, digitized images using previous approaches may require labor, time, or knowledge. Historically, a set of traditional drafting tools (e.g., straightedge, compass, ruler, and/or templates) would be employed to formalize drawings. However, digitization of drawings may involve the use of sophisticated software having cost and time barriers for users. In some approaches, users can send drawings out to a service or draftsperson to be digitized (at a cost). Some would-be drawers may attempt to consult one or more software image libraries (e.g., Clip art), only to be frustrated by endless browsing, difficulty searching, or a lack of the specific image(s) they seek.

Embodiments of the present disclosure can take a hand-drawn drawing, identify its features, and present a digitized image based on a comparison of those features with features of digitized images in an image library. In some embodiments, a picture of the drawing can be captured by an imaging device (e.g., a camera). In some embodiments, the drawing can be made using a touchscreen display. In some embodiments, the drawing can be received from a separate device (e.g., via message, email, etc.). The features identified can include, for example, line segments, arcs, single-point inputs (e.g., dots), and/or shapes. When directly input into a computing device, as in cases of a touchscreen display, a digitized image can be provided even before the user is finished drawing. Accordingly, frustrations stemming from the effort, time, and expertise associated with previous approaches can be reduced.

In some embodiments, the image library from which the digitized images are chosen for comparison can be one of a plurality of available image libraries. That is, embodiments herein can reduce time and provide better results by focusing the comparison on a subset of what may be a large amount of digitized images. The particular library used for comparison with the drawing can be selected based on one or more criteria. In some embodiments, the user can select the particular library (e.g., from a list). In some embodiments, the particular library can be selected without specific user input (e.g., automatically). Such selection can be made based on the context of the drawing.

Context, in accordance with the present disclosure, is a set of circumstances relevant to the determination of what features a drawing may depict. Contexts include, for example, location context, time context, occupation context, and user context. For example, a person who works as an optical engineer may be expected to draw certain kinds of drawings on their smartphone at their office during weekdays. These could include, for instance, block diagrams and/or optical diagrams. That same smartphone, however, may be expected to have different kinds of drawings drawn on it during the evening at home by their 5-year-old child. These could include, for instance, triceratopses, people, and/or horses. Embodiments herein can take these different contextual factors into account when selecting an image library for comparison. As a result, the digitized image(s) compared can be better suited to what may actually be drawn.

Some embodiments of the present disclosure include a method comprising receiving, by a controller, data representing a user drawing, identifying a feature of the user drawing based on the data, comparing the feature of the user drawing to features of a plurality of digitized images, and displaying a particular digitized image of the plurality of digitized images based on the comparison of the feature with the features of the plurality of digitized images and a context of the user drawing.

Some embodiments of the present disclosure include an apparatus comprising a display, a memory device, and a controller coupled to the memory device configured to receive data representing a user drawing, identify a feature of the user drawing based on the data, and compare the feature of the user drawing to features of a plurality of digitized images. The display can be configured to display a particular digitized image of the plurality of digitized images based on the comparison by the controller of the feature with the features of the plurality of digitized images. As used herein, an “apparatus” can refer to, but is not limited to, any of a variety of structures or combinations of structures, such as a circuit or circuitry, a die or dice, a module or modules, a device or devices, or a system or systems, for example.

Yet other embodiments of the present disclosure can include a non-transitory machine-readable medium comprising a processing resource in communication with a memory resource having instructions, which when executed by the processing resource, cause the processing resource to receive data representing a user drawing, identify a feature of the user drawing based on the data, compare the feature of the user drawing to features of a plurality of digitized images of a particular image library, and provide a particular digitized image of the plurality of digitized images via a display based on the comparison of the feature with the features of the plurality of digitized images.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

As used herein, designators such as “N,” etc., particularly with respect to reference numerals in the drawings, indicate that a number of the particular feature so designation can be included. It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

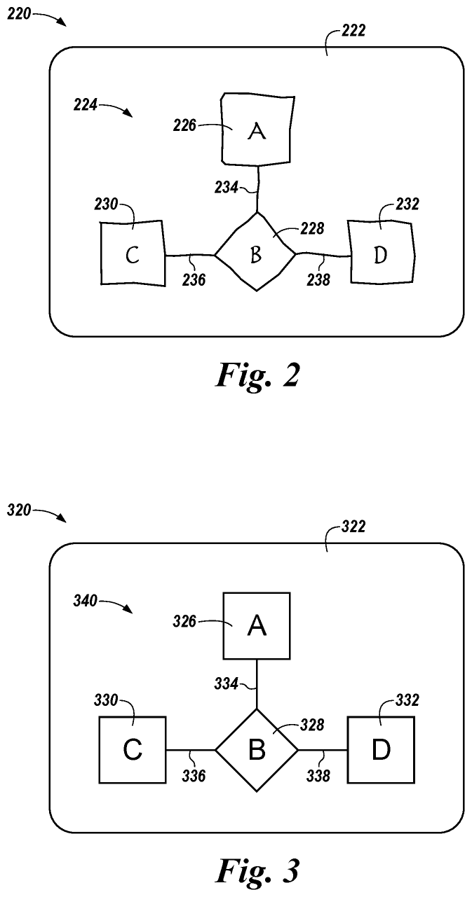

The figures herein follow a numbering convention in which the first digit or digits correspond to the figure number and the remaining digits identify an element or component in the figure. Similar elements or components between different figures can be identified by the use of similar digits. For example, 222 can reference element “22” in FIG. 2, and a similar element can be referenced as 322 in FIG. 3. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

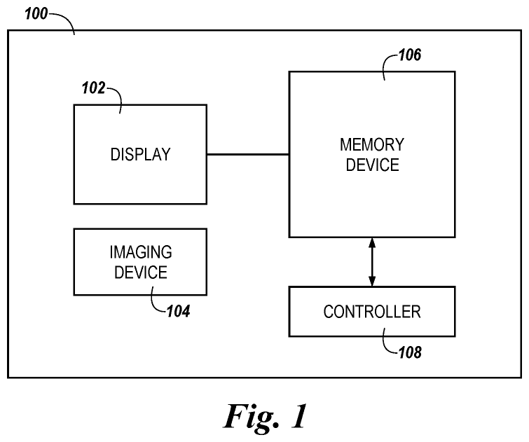

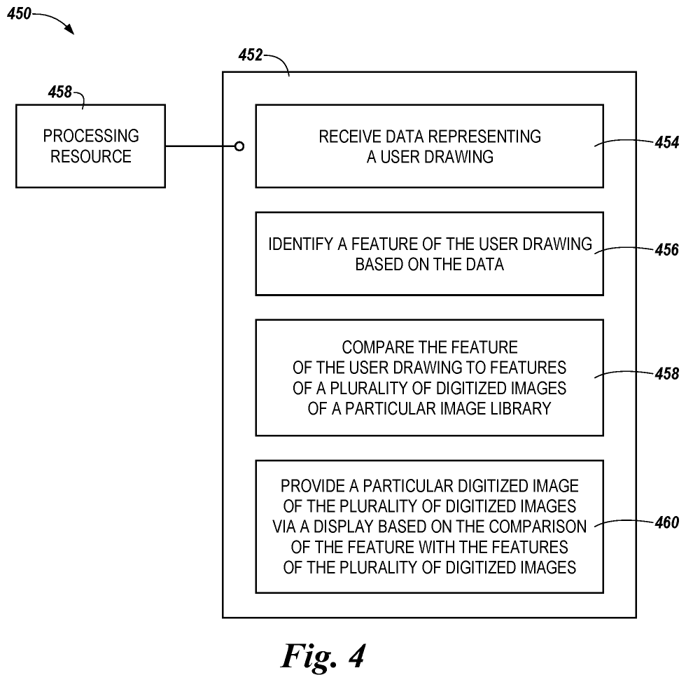

FIG. 1 is a functional block diagram in the form of a computing system including an apparatus 100 having a display 102, an imaging device 104, a memory device 106, and a controller 108 (e.g., a processor, control circuitry, hardware, firmware, and/or software) in accordance with a number of embodiments of the present disclosure. The memory device 106, in some embodiments, can include a non-transitory machine-readable medium (MRM), and/or can be analogous to the memory resource 452 described with respect to FIG. 4. The apparatus 100 can be a computing device; for instance, the display 102 may be a touchscreen display of a mobile device such as a smartphone. The controller 108 can be communicatively coupled to the memory device 106 and/or the display 102. As used herein, “communicatively coupled” can include coupled via various wired and/or wireless connections between devices such that data can be transferred in various directions between the devices. The coupling need not be a direct connection, and in some examples, can be an indirect connection. The imaging device 104 can be a camera, for instance, such as one known to those skilled in the art.

The memory device 106 can include non-volatile or volatile memory. For example, non-volatile memory can provide persistent data by retaining stored data when not powered, and non-volatile memory types can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such as phase change random access memory (PCRAM), three-dimensional cross-point memory (e.g., 3D XPoint™), resistive random access memory (RRAM), ferroelectric random access memory (FeRAM), magnetoresistive random access memory (MRAM), and programmable conductive memory, among other types of memory. Volatile memory can require power to maintain its data and can include random-access memory (RAM), dynamic random-access memory (DRAM), and static random access memory (SRAM), among others.

The controller 108 can receive data representing a user drawing. In some embodiments, the data can be received as data from an imaging device. An image (e.g., a picture) can be captured using the imaging device 104. For example, a user can capture a picture of a drawing drawn on a tangible medium (e.g., a whiteboard) using the imaging device 104. The picture can be received by the controller 108. In some embodiments the data can be received as one or more inputs drawn on the display 102 with a finger or stylus, for instance. For example, one or more line strokes made by a trace of a user's finger across the display 102 can be received as data representing a user drawing. Each line stroke can represent a trace or a portion of a trace of a moving input point used to create the drawing. In some embodiments, the drawing can be made without the use of a tangible medium. For instance, a user can wear an augmented reality (AR) device or virtual reality (VR) device, such as a headset, and embodiments herein can track movements of a hand or stylus using the AR or VR device.

The controller 108 can identify a feature of the drawing based on the data. A feature can include a line segment, an arc, a single-point input (e.g., dot), and/or shapes (e.g., triangles, rectangles, etc.). The identification of a feature can be accomplished by various techniques. For example, in some embodiments the controller 108 can identify line segments from a line stroke by decomposing the line stroke into various building blocks (e.g., straight lines and curved lines). In some embodiments, the controller 108 can utilizes a Hough transform to identify features. For example, the controller 108 can analyze the input(s) to identify and extract drawing features by use of a Hough transform algorithm. In some embodiments, the controller 108 can use the Hough transform, or another image feature identification and extraction technique, to generate a vector graphics representing the drawing. A vector graphics representation is a representing a drawing that characterizes the drawing in terms of its constituent elements (e.g., primitive geometrical elements, such as points, lines and curves). Thus, for example, the vector graphics representation represents the drawing as a mathematical expression based on the drawing's line segments.

The controller 108 can compare the feature of the user drawing to features of a plurality of digitized images. A feature of one of the plurality of digitized images represents a portion or all of a corresponding digitized image. In some embodiments, the plurality of digitized images can be images of a particular image library selected from among a plurality of image libraries having different digitized images therein.

The controller 108 can compare the features to determine a similarity or dissimilarly measure between the sets of features. The controller 108 can then use this measure of similarity or dissimilarly of features to determine if the corresponding drawings are similar or not. In some embodiments, the features of the user drawing can be compared with features of the plurality of digitized images to determine whether the similarity measure exceeds a similarity threshold. The similarity measure can be determined in a variety of ways. In some embodiments, the similarity measure can be determined by cosine similarity measures of feature vectors that describe the line segments, by spatial distance measurements, or any other suitable process that can determine a similarity between two sets of features.

The controller 108 can cause the display 102 to display a particular digitized image of the plurality of digitized images based on the comparison of the feature with the features of the plurality of digitized images. In some embodiments, for instance, the displayed digitized image can be a digitized image having a threshold-exceeding similarity to the drawing. In some embodiments, the controller 108 can score the similarity between the drawing and one or more digitized images and identify one or more digitized images as candidate images based on the similarity score(s) for the digitized image(s) meeting a threshold value. The threshold value can be a predefined value or can be a sliding value based on the similarity scores of the digitized images. For example, the threshold value may be set to identify the top three most similar digitized images as candidate images.

FIG. 2 is a diagram representing an example of a user drawing 224 on a display 222 of a computing device 220 in accordance with a number of embodiments of the present disclosure. Computing device 220, for instance, may be a smartphone with a touchscreen display 222. A user may draw the drawing 224 with his or her finger or a digital pen, for example. The particular shape of the drawing 224 is not limited to that illustrated in FIG. 2.

As described herein, embodiments of the present disclosure can identify a feature of a user drawing. A plurality of features is identified in the drawing 224. Features identified in the drawing 224 include a plurality of shapes and a plurality of line segments. For instance, identified in the drawing 224 is a drawn “A” rectangle 226, a drawn “B” diamond 228, a drawn “C” rectangle 230, a drawn “D” rectangle 232, a first drawn line segment 234, a second drawn line segment 236, and a third drawn line segment 238. As described herein, the features of the drawing 224 can be compared to features of a plurality of digitized images. In some embodiments, a single digitized image includes features similar to all the features of the user drawing. In some embodiments, a single digitized image includes fewer than all the features of the user drawing. In such cases, multiple digitized images can be combined such that the resulting combination is sufficiently similar to the user drawing.

FIG. 3 is a diagram representing an example of a digitized image 340 displayed on the display 322 of the computing device 320 based on the comparison of the features of the user drawing 224 of FIG. 2 with the features of the plurality of digitized images in accordance with a number of embodiments of the present disclosure. A plurality of features is seen in the digitized image 340, including a plurality of shapes and a plurality of line segments. For instance, the digitized image 340 includes an “A” rectangle 326, a “B” diamond 328, a “C” rectangle 330, a “D” rectangle 332, a first line segment 334, a second line segment 336, and a third line segment 338. As seen with reference to FIGS. 2 and 3, each of the features in the digitized image 340 corresponds to a respective feature in the drawing 224. The drawn “A” rectangle 226 corresponds to the “A” rectangle 326. The drawn “B” diamond 228 corresponds to the “B” rectangle 328. The drawn “C” rectangle 230 corresponds to the “C” rectangle 330. The drawn “D” rectangle 232 corresponds to the “D” rectangle 332. The first drawn line segment 234 corresponds to the first line segment 334. The second drawn line segment 236 corresponds to the second line segment 336. The third drawn line segment 238 corresponds to the third line segment 338. The digitized image 340, when compared with the drawing 224, has straight lines, sharp corners, and an increased professionalism.

FIG. 4 is a functional diagram representing a processing resource 458 in communication with a memory resource 452 having instructions 454, 456, 458, 460 stored thereon for presentation of digitized images from user drawings in accordance with a number of embodiments of the present disclosure. The memory resource 452, in some embodiments, can be analogous to the memory device 106 described with respect to FIG. 1. The processing resource 458, in some examples, can be analogous to the controller 108 described with respect to FIG. 1.

A system 450 can be a server or a computing device (among others) and can include the processing resource 458. The system 450 can further include the memory resource 452 (e.g., a non-transitory MRM), on which may be stored instructions, such as instructions 454 and 456. Although the following descriptions refer to a processing resource and a memory resource, the descriptions may also apply to a system with multiple processing resources and multiple memory resources. In such examples, the instructions may be distributed (e.g., stored) across multiple memory resources and the instructions may be distributed (e.g., executed by) across multiple processing resources.

The memory resource 452 may be electronic, magnetic, optical, or other physical storage device that stores executable instructions. Thus, the memory resource 452 may be, for example, a non-transitory MRM comprising Random Access Memory (RAM), an Electrically-Erasable Programmable ROM (EEPROM), a storage drive, an optical disc, and the like. The memory resource 452 may be disposed within a controller and/or computing device. In this example, the executable instructions 454, 456, 458, 460 can be “installed” on the device. Additionally or alternatively, the memory resource 452 can be a portable, external or remote storage medium, for example, that allows the system 450 to download the instructions 454, 456, 458, 460 from the portable/external/remote storage medium. In this situation, the executable instructions may be part of an “installation package”. As described herein, the memory resource 452 can be encoded with executable instructions for presentation of digitized images from user drawings.

The instructions 454, when executed by a processing resource such as the processing resource 458, can include instructions to receive data representing a user drawing. The user drawing represented by the data is a non-digitized drawing made by a human. The data can be received from an input made into a touchscreen display, for instance, or from an imaging device, though it is noted that embodiments herein are not so limited.

The instructions 456, when executed by a processing resource such as the processing resource 458, can include instructions to identify a feature of the user drawing based on the data. Features, as described herein, include line segments, arcs, points, shapes, etc. Identification of such features in the user drawing can be accomplished in various manners, such as those described previously herein.

The instructions 458, when executed by a processing resource such as the processing resource 458, can include instructions to compare the feature of the user drawing to features of a plurality of digitized images of a particular image library. In some embodiments, a particular image library can be consulted responsive to a user selection of that image library (e.g., from a list of image libraries). The names of the image libraries can be displayed in a user-configurable manner. In some embodiments, one or more sample images from the image library are displayed to convey the type, style, or content of the image libraries.

In some embodiments, the particular image library can be selected without user input (e.g., automatically). The selection of the particular image library can be made based on historical image libraries used by the user, for instance. In some embodiments a list of previously-used image libraries can be made available on the display for selection. As previously discussed, the particular image library can be selected based on context. Different image libraries may have varying degrees of relevance depending on where the drawing is being drawn (e.g., location context), when the drawing is being drawn (e.g., time context), what the user does (e.g., occupation context), and who the user is (e.g., user context).

Factors bearing on location context are factors concerning where the computing device (and, by extension, the user) is. Such factors include a country, state, or town where the computing device is located. Additionally, such factors can include whether the user is indoors or outdoors. A user outdoors may be expected to be drawing building exteriors or nature subjects more so than one indoors. Additional factors can include whether the user is home or away from home, or at work or away from work. Factors bearing on time context are factors concerning the temporal aspects of a drawing. Such factors include time of day, day of week, and season, for instance. For example, a drawing made during a workday may be more likely to include diagrammatical features than one being drawn at 8:00 pm on a Saturday. Further, a particular library selected for comparison with a drawing made in the winter would be more likely to include a snowman than one selected for a drawing made in the summer. Factors bearing on occupation context are factors concerning what the user does. Such factors can include a type of industry in which the user works (e.g., business, construction, manufacturing, transportation, food service, etc.), a type of occupation engaged in by the user (e.g., salesperson, laborer, driver, engineer, etc.), whether the user is a manager or a lower-level employee, what tools with which the user typically works, and others. Factors bearing on user context are factors concerning who the user is. The identity of the user drawing the drawing can be determined through a user login, through biometric recognition, or by other manners. In some embodiments, a user may enter or select these factors to provide embodiments herein with increased context regarding the types of drawings they may draw. User context factors can include the age of the user, the gender of the user, activities performed by the user (e.g., hobbies, sports, clubs, etc.), family members of the user, and interests of the user, for instance.

Multiple contexts can be considered simultaneously. For example, a drawing made on the Fourth of July by a first user in Indonesia may not carry the same contextual weight as one being made on the Fourth of July by second user in America. The particular library selected for the second user would be more likely to include patriotic American digitized images than would the particular library selected for the first user. Further, images commonly associated with a particular religious holiday may not be of particular relevance to a user drawing something on that day who does not celebrate the holiday.

The instructions 460, when executed by a processing resource such as the processing resource 458, can include instructions to provide a particular digitized image of the plurality of digitized images via a display based on the comparison of the feature with the features of the plurality of digitized images. In some embodiments, the particular digitized image can be provided (e.g., suggested) before the user is finished drawing. In some embodiments, the user may prefer to finish a drawing before being provided with the digitized image and can deactivate this feature.

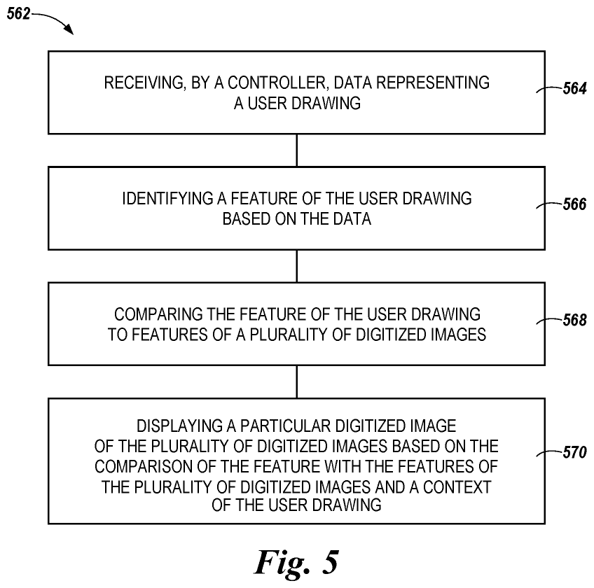

FIG. 5 is a flow diagram representing an example method 562 for presentation of digitized images from user drawings in accordance with a number of embodiments of the present disclosure. At 564, the method 562 includes receiving, by a controller, data representing a user drawing. The data can be received in different forms. For example, the data can be in the form of image data (e.g., from an image sensor or imaging device), the data can be in the form of input data from a touchscreen display. In some embodiments, the data can be input into a separate device, such as a different touchscreen display of a separate device.

At 566, the method 562 includes identifying a feature of the user drawing based on the data. Feature identification can be accomplished by various techniques, such as those described herein. For example, features can be identified using a Hough transform. Features identified can include constituent elements, such as points, lines, and/or curves, among other elements.

At 568, the method 562 includes comparing the feature of the user drawing to features of a plurality of digitized images, and at 570, the method 562 includes displaying a particular digitized image of the plurality of digitized images based on the comparison of the feature with the features of the plurality of digitized images and a context of the user drawing. In some embodiments, digitized images having features with a threshold-exceeding similarity to those of the drawing can be presented (e.g., displayed). In some embodiments, suggestions regarding the particular digitized image can be made while the drawing is still being drawn. The user can select or otherwise indicate approval of the suggestion of the particular digitized image.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, by a controller, data representing a user drawing;
identifying a feature of the user drawing based on the data;
comparing the feature of the user drawing to features of a plurality of digitized images; and
displaying a particular digitized image of the plurality of digitized images based on the comparison of the feature with the features of the plurality of digitized images and a context of the user drawing.

2. The method of claim 1, wherein receiving the data representing the user drawing includes receiving an input made using a touchscreen display.

3. The method of claim 1, wherein receiving the data representing the user drawing includes receiving an image of the user drawing.

4. The method of claim 1, wherein receiving the data representing the user drawing includes receiving the data from a computing device.

5. The method of claim 1, wherein identifying the feature of the user drawing includes identifying a line segment.

6. The method of claim 1, wherein identifying the feature of the user drawing includes identifying a shape.

7. The method of claim 1, wherein the plurality of digitized images is stored in an image library, and wherein the method includes selecting the image library from among a plurality of different image libraries.

8. The method of claim 1, wherein the method includes displaying the particular digitized image responsive to a determination that the feature of the user drawing and a digitized feature of the particular digitized image exceed a similarity threshold.

9. The method of claim 1,
wherein receiving the data representing the user drawing includes receiving a plurality of inputs made using a touchscreen display; and
wherein the method includes:
identifying the feature of the user drawing based on the data while the plurality of inputs is being received;
comparing the feature of the drawing to the features of the plurality of digitized images while the plurality of inputs is being received; and
displaying the particular digitized image of the plurality of digitized images based on the comparison of the feature with the features of the plurality of digitized images while the plurality of inputs is being received.

10. The method of claim 1,
wherein receiving the data representing the user drawing includes receiving a plurality of inputs made using a touchscreen display; and
wherein the method includes:
identifying the feature of the user drawing based on the data after the plurality of inputs is received;
comparing the feature of the drawing to the features of the plurality of digitized images after the plurality of inputs is received; and
displaying the particular digitized image of the plurality of digitized images based on the comparison of the feature with the features of the plurality of digitized images after the plurality of inputs is received.

11. A non-transitory machine-readable medium comprising a processing resource in communication with a memory resource having instructions, which when executed by the processing resource, cause the processing resource to:
receive data representing a user drawing;
identify a feature of the user drawing based on the data;
compare the feature of the user drawing to features of a plurality of digitized images of a particular image library; and
provide a particular digitized image of the plurality of digitized images via a display based on the comparison of the feature with the features of the plurality of digitized images.

12. The medium of claim 11, including instructions to provide a plurality of image libraries, each including a different plurality of digitized images.

13. The medium of claim 12, including instructions to receive a user selection of the particular image library from among the plurality of image libraries.

14. The medium of claim 12, including instructions to select the particular image library from among the plurality of image libraries based on a location context.

15. The medium of claim 12, including instructions to select the particular image library from among the plurality of image libraries based on a time context.

16. The medium of claim 12, including instructions to select the particular image library from among the plurality of image libraries based on a user occupation context.

17. The medium of claim 12, including instructions to select the particular image library from among the plurality of image libraries based on a historical user drawing.

18. An apparatus, comprising:
a display;
a memory device;
a controller coupled to the memory device configured to:
receive data representing a user drawing;
identify a feature of the user drawing based on the data; and
compare the feature of the user drawing to features of a plurality of digitized images; and
wherein the display is configured to display a particular digitized image of the plurality of digitized images based on the comparison by the controller of the feature with the features of the plurality of digitized images.

19. The apparatus of claim 18, wherein the apparatus is a mobile device, wherein the display is a touchscreen display, and wherein the controller is configured to receive the data representing the user drawing via the touchscreen display.

20. The apparatus of claim 18, wherein the apparatus includes a camera, and wherein the controller is configured to receive the data representing the user drawing via an image of the drawing captured by the camera.
